(19) United States
(12) Patent Application Publication
(10) Pub. No.: US 2024/0067550 A1
(43) Pub. Date: Feb. 29, 2024

(54) PROCESS FOR TREATING WATER

(71) Applicant: Infinite Water Technologies Pty Ltd, Rosebery (AU)

(72) Inventors: Gheorghe Emil DUTA, Rosebery (AU); Kalaruban MAHATHEVA, Rosebery (AU)

(73) Assignee: Infinite Water Technologies Pty Ltd, Rosebery (AU)

(21) Appl. No.: 18/266,196

(22) PCT Filed: Dec. 10, 2021
(86) PCT No.: PCT/AU2021/051474

§ 371 Date: Jun. 8, 2023

(30) Foreign Application Priority Data
Dec. 10, 2020 (AU) 20209046404

(51) Int. Cl. C02F 9/00

(52) U.S. Cl. CPC C02F 9/00; C02F 1/725

(57) ABSTRACT

Provided herein is a process for treating water containing natural organic matter (NOM) to produce potable water, the process comprising a plurality of oxidation steps for degrading NOM, wherein the plurality of oxidation steps comprise one or more of subjecting water to inorganic oxidant, oxygenation, catalytic oxidation, and catalytically advanced oxidation (CAO). Also provided herein is a process for treating water for producing potable water, the process comprising a plurality of oxidation steps; wherein the plurality of oxidation steps comprise one or more of fragmentation of NOM with ozone, homogeneous catalytic oxidation with ozone, and catalytically advanced oxidation using granular metal oxide catalyst.

### FIELD

This disclosure relates to a process for treating water to produce potable water.

### BACKGROUND

The rapid growth of population and urbanization have continuously increased the pressures on existing drinking-water resources and resulted in deterioration of water quality available for treatment. The world population is projected to pass 9.6 billion by 2050 while urban population is anticipated to grow to 6.3 billion. An increase in agricultural activities for food production results in increased organic matter and nutrient addition to the water bodies. Nutrients cause more frequent and more severe algal blooms and an overall increase in natural organic matter (NOM) in the water causes increased difficulties with containing disinfection by-products (D3Ps) within health safe limits. High NOM in the treated water also causes biofouling of the water distribution networks, compromises water disinfection and cause objectionable water smell and taste. Water colour increases and becomes more difficult to remove when a large amount of vegetation and tree leaves decompose. Furthermore, a broad range of contaminants of emerging concern (CECs) from household products, industrial activity and agricultural pesticides, herbicides, growth enhancing hormones and antibiotics end up in significant amounts in the water to be used for production of potable water. Water utilities have gradually adopted a range of solutions for reducing dissolved NOM and reduction of other organic contaminants.

Enhanced coagulation, a typical step in water treatment processes, relies on addition of a relatively large amount of coagulating metal salts such as aluminium sulphate, aluminium chloride or ferric chloride to adsorb natural organic matter onto the coagulant and remove the NOM with the sludge settled at a further flocculation and clarification step. According to enhanced coagulation D/DBP rules in the United States, the removal requirements for total organic carbon (TOC) is maximum 50% if the alkalinity is lower than 60 mg/L as calcium carbonate and TOC in raw water is greater than 8 mg/L. However, to have certainty that D3Ps formed through chlorination will not exceed regulatory requirements, the TOC should be not greater than 2 mg/L. This is difficult to achieve through enhanced coagulation and consequently, very many water utilities must use additional means to remove the TOC.

Addition of powder activated carbon (PAC) before clarification may solve the problem of removing NOM to prevent excessive DBPs in the product chlorinated, i.e. disinfected, water. This tends to add much to the treatment cost and the solution is practical only if the amount of dissolved organic matter to be removed is not very high and the excess occurs, typically seasonally, for a short time.

Pre-oxidation with potassium permanganate is used successfully on some types of water if the concentration of NOM is not high. Addition of potassium permanganate is limited by pink colour of the residual permanganate which may end up in the treated water causing a further problem. Also, the added manganese may prove difficult to remove.

Pre-oxidation with ozone is often practised, but has shown to be energy intensive and forms its own disinfection by products. Furthermore, the NOM in large part tends to be simply fragmented, increasing the biodegradable organic carbon. Then, biofouling of the plant and distribution network becomes a serious problem.

Pre-oxidation with ozone followed by biological activated carbon (BAC) filtration is a potential solution gaining more and more acceptance. The cost of using activated carbon decreases due to the long lifetime of the activated carbon before replacement is needed. The pre-oxidation with ozone is usually limited to fragmentation of organic matter to improve biodegradation. Ozone dosage is less than 5 mg/L and energy usage and cost are acceptable. However, the fragmented organic matter might not be always easy to biodegrade. Sometimes the removal of dissolved organic carbon through ozonation followed by biological activated carbon filtration is as low as 10%. A maximum removal expected is rarely greater than 35%.

Magnetic ion Exchange (MIEX) resin successfully removes dissolved organic matter to a reasonable degree but the implementation of the system to use the resin is complex and cost of treatment is high. In addition, the resin is regenerated with brine and the resulting waste is difficult to dispose of safely. In spite of these limitations, the MIEX removal of dissolved NOM has been applied in many plants in countries where DBPs are restricted to lower concentration limits.

Degradation of dissolved NOM using advanced oxidation based on UV/H₂O₂ is applicable and has met with success where the concentration of NOM is not very high, preferably lower than 6 mg/L as DOC. This is because energy consumption and cost becomes too high to be accepted. With regard to degradation of CECs, the UV/H₂O₂ combination process has the merit of degrading such substances taking them out of the environmental cycle.

Thus, primarily due to cost and/or limitations in addressing high concentration of dissolved NOM, current technologies have encountered difficulties in successfully resolving the ever increasing depreciation of raw water quality available for treatment. Water treatment for the production of potable water has to address a multitude of problems such as and without limitation: high dissolved NOM as well as high colour, algae and algal products causing bad taste in the water, algal toxins, heavy metals (most common are iron and manganese) pathogens and CECs.

In view of the foregoing, it would be desirable to identify new processes for treating water to produce potable water.

The reference in this specification to any prior publication (or information derived from it), or to any matter which is known, is not, and should not be taken as an acknowledgement or admission or any form of suggestion that the prior publication (or information derived from it) or known matter forms part of the common general knowledge in the field of endeavour to which this specification relates.

### SUMMARY

The present disclosure provides a more efficient and cost effective water treatment process for producing potable water by treating fresh water from natural sources to degrade and remove one or more of NOM, heavy metals, algal toxins, and CECs, and disinfect the water.

The present disclosure also provides an advanced oxidation process solution for upgrading existing utility plants for the production of drinking water. The scope of the upgrade improves overall water quality, minimizes NOM and CECs in the treated water and decreases the formation of disinfection by-products at lower cost than conventional technologies.

In one aspect, the present disclosure provides a process for treating water containing natural organic matter (NOM) to produce potable water, the process comprising a plurality of oxidation steps for degrading NOM,
wherein the plurality of oxidation steps comprise one or more of subjecting water to inorganic oxidant, oxygenation, catalytic oxidation, and catalytically advanced oxidation (CAO).

In embodiments, the process further comprises the step of subjecting the water to biological filtration, such as biological activated carbon (BAC) filtration.

In additional or alternate embodiments, the process further comprises the step of contacting water with granular activated carbon (GAC) for removal of remaining organic matter and for removal of potentially toxic fraction resulting from degradation of organic matter.

In additional or alternate embodiments, the process further comprises treating water with chlorine to provide a residual disinfectant level in the water.

In embodiments, the process has the advantages of achieving a low NOM content in treated water and, to the extent NOM is present, a refractory portion of NOM which is essentially unreactive with chlorine, i.e., the NOM is too refractory to react with chlorine to form a harmful level of disinfection by-products (DBP).

The refractory portion of NOM left after the oxidation steps may have a lower average molecular weight than the average molecular weight of NOM in raw water. This makes it easier to remove by absorption on, for example, GAC. Loading capacity is increased because the pores in the GAC are not blocked by large molecules. Other common contaminants, as mentioned above, are also expected to be removed by the process.

In embodiments, the oxidation steps include steps such as contacting water with an inorganic oxidant, oxygenation, catalytic oxidation, and catalytic advanced oxidation, desirably in this order, though oxygenation may be used in intermediate catalytic oxidation-catalytic advanced oxidation reaction steps. Depending on the nature and level of NOM, a plurality of catalytic oxidation-catalytic advanced oxidation steps may be required. Indeed, total oxygen addition to the process may desirably depend on the nature and level of the NOM present in water.

Oxygen additions, whether through gaseous or oxidising salt additions, may be controlled to achieve oxidation of NOM and other oxidisable contaminants based on the nature and content of NOM. Due to the demand for oxygen in the oxidation steps, it may be necessary to boost the dissolved oxygen level of the water through one or more steps selected from the group consisting of: treating water in a pressurised reactor, contacting water with an oxygen containing gas containing more than 21 vol % oxygen, and preferably greater than 85 vol % oxygen, introducing an oxygen donor, for example hydrogen peroxide or a permanganate which may, in turn, depend on the stage of the process (i.e., if further oxygen is needed at a catalytic oxidation-catalytic advanced oxidation stage it may be preferred to use an oxidant, such as hydrogen peroxide or ozone, that does not form a quantity of precipitates on reaction with contaminants or other components in the water or introduce undesirable colouration if a permanganate, for example, is used or a combination of these dependent on the content and nature of NOM present in the water.

As to nature of NOM, lower molecular weight organic matter resulting from degradation through CAO tends to be more refractory to oxidative treatment. The content of NOM may be determined by conventional analytical techniques such as UV transmittance. The above plurality of oxidation steps also reduce the level of other contaminants including heavy metal and algal toxins. However, removal of such contaminants does not necessarily indicate that NOM levels would be reduced to avoid formation of harmful DBP levels on exposure to chlorine as indicated above.

Hydrogen peroxide or ozone may usefully be used to boost oxygen levels where the NOM level requires a plurality of catalytic oxidation—catalytic advanced oxidation (CO-CAO) steps to reduce NOM content and it is undesirable to add colour and/or form solids, such as hydroxides, which may interfere with CO-CAO reactor operation or require excessive backwashing.

Fragmented organic matter through ozonation has usually a higher degree of polarity and electric charge. Consequently, this opens the possibility to use catalytic advanced oxidation (CAO) process as described herein to substitute BAC and achieve higher efficiency in removal of NOM.

A large part of fragmented organic matter may be neutral and also biodegradable. Neutral organic matter cannot be degraded through CAO as is not attracted to the surface of the catalyst. Hence, another possibility is to use ozonisation followed by BAC, then CAO for maximising efficiency of degradation of NOM.

In embodiments, the process for treating water comprises the steps of:
a) adjusting pH of water to a pH between 4 and 6;
b) forming reactive radicals, such as hydroxyl radicals, for example by adding a hydrolysing iron salt to the water of step (a);
c) oxygenating the water of step b) with an oxygen containing gas containing more than about 21% oxygen for degrading a substantial portion of organic matter;
d) coagulating suspended and colloidal solids where formed in step (c);
e) adding an oxygen donor oxidant to the water, for partial oxidation and to provide oxygen for catalytic oxidation step (f);
f) subjecting the water from step (e) to catalytic oxidation and catalytic advanced oxidation (CO-CAO) to degrade contaminants leaving a refractory portion of NOM;
g) optionally subjecting the water to GAC filtration for removal of refractory and potentially toxic residual organic matter.

In embodiments, the process further comprises the step of subjecting the water to biological filtration, such as biological activated carbon (BAC) filtration.

In additional or alternate embodiments, the process further comprises treating water with chlorine to provide a residual disinfectant level in the water.

pH adjustment in step (a) typically requires water to be acidified following which, in step (b), an iron salt, conveniently ferric chloride, is added to provide conditions for Fenton like reaction to take place and degrade a portion of NOM and other oxidisable contaminants present in the water through reaction with reactive radicals in a Fenton like scheme. The amount of iron salt added is dependent on the NOM content of the water which may conveniently be measured by conventional analytical techniques such as UV transmittance. Expected maximum efficiency of the process is around pH 4 but lowering the pH to 4 and increasing the pH to the level suitable for drinking water may add much treatment cost. In some cases, desired treatment may be achieved by lowering the pH to about 5.5.

Oxygenation step (c) is advantageously conducted under pressure with oxygen or oxygen enriched air being introduced to the water through a suitable injection means or diffuser, such as a bubble diffuser. Desirably, oxygenation step (c) is conducted in enclosed reactor(s) including a headspace with oxygen content target controlled substantially above 21 vol % oxygen. Preferably, oxygen content target is above 85 vol % oxygen. The injection means or diffuser is most conveniently in communication with an oxygen generator, conveniently a pressure swing adsorption generator which can produce 90% to 93% oxygen concentration. According to Henry's law, the oxygen content in the headspace of the tank could, for example and desirably, approach 90 vol % and consequently the dissolved oxygen in the water could increase, for example around 30 mg/L oxygen under favourable conditions. Oxygen flow from the oxygen generator and through the injection means or diffuser is controlled to meet the water dissolved oxygen content target described above. Under the conditions of low pH, presence of dissolved iron and high concentration of oxygen in the water, Fenton like advanced oxidation reactions will take place degrading in part the NOM and CECs. Part of the organic matter will be fragmented into smaller molecules. Volatile organic matter will be stripped off and in part oxidised.

Coagulation step (d) involves increasing pH of the water using an alkali such as hydrated lime or sodium hydroxide. Coagulation step (d) is conveniently performed in baffled tank(s) with baffles defining compartments each provided with a mixer. Mixer speed may be controlled to optimise mixing or coagulation as required with mixer(s) in different compartments being desirably run at different speeds. Water entering a first compartment may have a mixer run at a higher speed to promote mixing. Second and/or subsequent compartments may have mixer(s) run at a lower speed to promote coagulation. While pH is rising and ferric hydroxide precipitates (typically with other metal hydroxides), some of the NOM will be adsorbed on the ferric hydroxide precipitate and removed in the sludge from the clarification step. If hydrated lime is used for increasing pH to cause coagulation, re-carbonation with carbon dioxide is preferably performed to precipitate residual calcium hydroxide by converting it to calcium carbonate. Then, water clarification to remove the precipitate is also typically needed.

Following coagulation step (d), flocculation would typically be conducted in suitable flocculation vessel(s) with flocculation being conveniently achieved using a polymeric flocculant. Preferably the polymer used is of amphoteric type. Desirably, the flocculation vessel(s) are open to atmosphere to enable settling of flocs.

If required, for example due to the water NOM content and amount of iron salt added, a clarification step to produce a clarified water and a sludge may be performed using any type of clarifier, though an inclined plate type is convenient, and sludge is likewise separated by conventional means. The clarification step may be performed after coagulation step (d). If, according to the preferred embodiment, the amount of suspended solids is small, say less than 10 mg/L, and NOM degradation and removal involves less iron salt addition with subsequent precipitation of less ferric hydroxide, settling and removal of sludge through a clarifier may be avoided because, in such case, the upper side of the first CO-CAO reactor will retain the flocculated matter without interfering with operability of the CO-CAO stage. As with additions of oxygen in the process, increase of pH is desirably performed by using an alkali which does not producing precipitate by itself. Sodium hydroxide or potassium hydroxide are examples of suitable alkalis.

Following coagulation, flocculation and clarification, where conducted due to the volume of sludge, the partially treated water still typically contains a range of undesirable contaminants including pathogens. Further oxidation is required. Water is therefore typically subjected to further oxygenation to increase or boost dissolved oxygen level in preparation for the CO-CAO step (f). Oxygen availability for the CO-CAO step is, highly desirably, further increased through oxygenation using an injection means such as a bubble diffuser, addition of an oxygen donor and, preferably, both. Control over oxygenation may be conducted in the same way as described for step (b), though contact time is typically less than for step (b). Such oxygenation is preferably conducted in a separate vessel to a CO-CAO reactor, the separate vessel also capable of facilitating backwashing as a break tank.

A preferred oxygen donor is a permanganate, conveniently potassium permanganate, which introduces another metal catalytic to oxidation, manganese. The oxygen donor should not be too strong an oxidant to directly oxidise ammonia. Ammonia oxidation has high oxidant demand and is highly desirably avoided in the water treatment process described herein. Depending on the concentration, ammonia may be removed from the water in an additional treatment stage by break point oxidation and other conventional methods, such as ion exchange. The water before entering the CO-CAO bed reactor(s) should have pH adjusted within a range of 6 to 9 and oxidation reduction potential (ORP) 400 mV or higher depending on pH.

Following addition of the oxygen donor and oxygenation, where boost oxygenation is required, the water is treated in one or more catalytic oxidation and catalytic advanced oxidation reactor(s) containing beds of granular oxidation catalysts, preferably selected metal oxides for oxidation of inorganic contaminants and advanced oxidation of organic matter. Suitable catalysts include oxides of iron, manganese, aluminium, silica and titanium whether alone or in combination.

Conveniently, though dependent on NOM content especially following step (b), step (f) involves a plurality, conveniently two, of bed reactors in series forming a CO-CAO reactor system. The first reactor preferably accommodates suspended solids at the top of the bed, for example by including a top layer of large size and lower density particles than the granular metal oxide catalysts included within the bed. For example, anthracite or particles of inorganic material including inert packings may be used for the top layer. The second or any subsequent reactor has a polishing role and does not contain the top layer of large size particles. If dissolved organic matter left following the first CO-CAO reactor is of more refractory nature and needs further degradation, hydrogen peroxide can be injected upstream from the second CO-CAO reactor as oxygen donor to boost water dissolved oxygen content for the advanced oxidation in the second reactor. At this stage, hydrogen peroxide is preferred because it does not produce precipitates by itself and only a very small amount of suspended solids which are expected to be retained in the bed of the second reactor. Further, this avoids the potential problem of excess colouration due to introduction of permanganate, though this must be weighed against requirement for a catalytic metal, such as manganese, to be present in the CO-CAO stage.

Without wishing to be bound by theory, highly reactive species, including hydroxyl radicals, are generated through the catalytic decomposition of the oxygen donor and metal oxidation state transition as in Fenton like reactions in the process. As a consequence of the ability of the CO-CAO reactor(s) to degrade organic matter such that only a portion of NOM refractory to oxidation is left, a high level of disinfection is achieved in this part of the process. The disinfection may be achieved without addition of any specific disinfectant containing chlorine which is highly desirable because common disinfectants result in formation of harmful DBPs when reacting with dissolved organic matter. That said, backwashing of the CO-CAO reactor(s) should be practised and chlorine or other disinfectant is desirably added to the backwashing water. To avoid problems with residual chlorine in the bed, and water directed to further treatment, in particular by adsorption, a rinsing stage to remove any residual chlorine is desirably conducted following backwashing.

Depending on level and nature of NOM and CECs present in the water and targeted water quality, an adsorption step, using an adsorbent such as granular activated carbon (GAC), may follow the catalytic advanced oxidation step. CO-CAO treatment as described above is expected to produce very low turbidity water, typically lower than 0.1 NTU with no suspended solids and very low metal content. The residual dissolved NOM level, after the earlier treatment steps, is expected to usually be lower than 4 mg/L as dissolved organic carbon (DOC). This is typically fragmented NOM with molecular weight of less than 5000 Daltons. This residual NOM may be adsorbed with high adsorption efficiency on GAC, and other adsorbents such as zeolites, with medium and fine pore size.

In another aspect, the present disclosure provides a water treatment process for treatment of water for producing potable water, the process comprising a plurality of oxidation steps;
wherein the plurality of oxidation steps comprise one or more of fragmentation of NOM with ozone, homogeneous catalytic oxidation with ozone, and catalytically advanced oxidation using granular metal oxide catalyst.

In additional or alternate embodiments, at least one of the oxidation steps comprises fragmentation of NOM with ozone and/or homogeneous catalytic oxidation with ozone.

In additional or alternate embodiments, the process comprises at least one oxidation step with ozone, followed by at least one oxidation step involving catalytically advanced oxidation using granular metal oxide catalyst.

In additional embodiments, the process further comprises the steps of subjecting the ozonated water to BAC filtration to remove the biodegradable organic matter fraction, followed by CAO using metal oxide catalyst.

In additional or alternate embodiments, the process further comprises the step of contacting water with granular activated carbon (GAC) for removal of remaining organic matter and for removal of potentially toxic fraction resulting from degradation of organic matter.

In additional or alternate embodiments, the process further comprises treating water with chlorine to provide a residual disinfectant level in the water.

In additional or alternate embodiments, the water to be treated is conventionally clarified or filtered water.

In this aspect, steps (a) through (d) as set out in paragraph [00027] may not be required. This may be the case for example where conventionally clarified or filtered water is being utilised as the feedstock.

The discussion above and below in relation to the first aspect regarding features such as fragmentation of NOM, homogeneous catalytic oxidation, ozonation, catalytically advanced oxidation using granular metal oxide catalyst, BAC filtration, contacting water with GAC, and treatment of water with chlorine, are also applicable to the second aspect.

By use of the processes described above, a potable water may be produced which has a low fraction of NOM and other contaminants and a low to negligible level of DBPs even where, as is typically practised, chlorine is added to the potable water at the end of the treatment process whether by custom or regulation. The remaining fraction of NOM after treatment is refractory to reaction with chlorine and formation of DBPs is minimised or avoided altogether.

### BRIEF DESCRIPTION OF THE DRAWINGS

The water treatment process of the present disclosure may be more fully understood from the following description of preferred and non-limiting embodiments thereof made with reference to the accompanying drawings.

FIG. 1, in accordance with one embodiment of the present disclosure, is a process diagram of a pre-conditioning stage for treatment of raw fresh water to be treated for first stage oxidation and clarification. This process configuration could be used when the raw water has relatively high concentration of suspended solids, colloidal matter and dissolved natural organic matter (NOM).

FIG. 2 is a process diagram of CO-CAO stage of treatment of fresh water for production of potable water following the pre-conditioning stage shown in FIG. 1 or FIG. 4. This process configuration could be used when the raw water has high concentration of dissolved NOM. Concentration of NOM in raw water could be as high as around 50 mg/L or even higher.

FIG. 3 is a process diagram for removal of low concentration of more refractory part of NOM and low concentration of various other dissolved contaminants, using a GAC filter adsorber. The configuration is typical for potable water production with two filter adsorbers in parallel. This module is used to treat the water from CO-CAO stage if needed to produce water with lower concentration of NOM and other contaminants.

FIG. 4, is a process diagram of a pre-conditioning stage for treatment of raw fresh water to be treated for first stage oxidation and clarification in accordance with another embodiment of the present disclosure. This process configuration could be used when the raw water has low concentration of suspended solids and colloidal matter and is of overall high quality. Clarification and sludge removal is not needed for this type of water. Consequently, the process here is simpler when compared to the process shown in FIG. 1.

FIG. 5 is a process diagram of CO-CAO stage of treatment of fresh water for production of potable water following the pre-conditioning stage shown in FIG. 1 or FIG. 4. This process configuration could be used when the raw water has relatively low concentration of dissolved NOM. Concentration of NOM should not be higher than around 8 mg/L.

FIG. 6 shows a High Pressure Size Exclusion Chromatography (HPSEC) plot of raw water dissolved NOM and dissolved NOM of water treated through a process according to an embodiment of the present disclosure.

FIG. 7 is a process diagram using ozonation in combination with CAO based on metal oxide catalyst according to an embodiment of the present disclosure. The process is used for treatment of clarified or filtered water, or typically for treatment of water with low suspended solids and more difficult to degrade NOM.

### DETAILED DESCRIPTION

The following is a detailed description of the disclosure provided to aid those skilled in the art in practicing the present disclosure. Those of ordinary skill in the art may make modifications and variations in the embodiments described herein without departing from the spirit or scope of the present disclosure.

Although any processes and materials similar or equivalent to those described herein can also be used in the practice or testing of the present disclosure, the preferred processes and materials are now described.

It must also be noted that, as used in the specification and the appended claims, the singular forms ‘a’, ‘an’ and ‘the’ include plural referents unless otherwise specified. Thus, for example, reference to ‘catalytically advanced oxidation’ may include more than one catalytically advanced oxidation, and the like.

Throughout this specification, use of the terms ‘comprises’ or ‘comprising’ or grammatical variations thereon shall be taken to specify the presence of stated features, integers, steps or components but does not preclude the presence or addition of one or more other features, integers, steps, components or groups thereof not specifically mentioned.

The following definitions are included to provide a clear and consistent understanding of the specification and claims. As used herein, the recited terms have the following meanings. All other terms and phrases used in this specification have their ordinary meanings as one of skill in the art would understand. Such ordinary meanings may be obtained by reference to technical dictionaries, such as Hawley's Condensed Chemical Dictionary 14th Edition, by R. J. Lewis, John Wiley & Sons, New York, N.Y., 2001.

Unless specifically stated or obvious from context, as used herein, the term “about” is understood as within a range of normal tolerance in the art, for example within two standard deviations of the mean. ‘About’ can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein in the specification and the claim can be modified by the term ‘about’.

Any processes provided herein can be combined with one or more of any of the other processes provided herein.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50.

Reference will now be made in detail to exemplary embodiments of the disclosure. While the disclosure will be described in conjunction with the exemplary embodiments, it will be understood that it is not intended to limit the disclosure to those embodiments. To the contrary, it is intended to cover alternatives, modifications, and equivalents as may be included within the spirit and scope of the disclosure as defined by the appended claims.

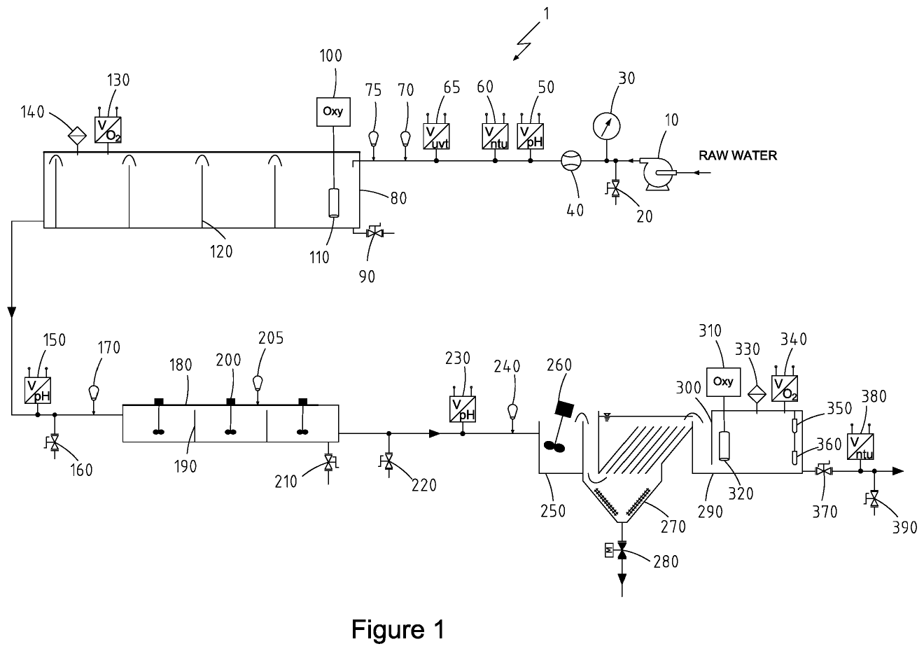

Referring to FIG. 1, there is schematically shown the pre-treatment module of a water treatment plant 1 to produce potable water. This pre-conditioning stage of water treatment plant 1 has the purpose of treating raw water in preparation for the catalytic and catalytic advanced oxidation stage. This process configuration is desirably used when the raw water has relatively high concentration of suspended solids, colloidal matter and dissolved NOM.

With reference to FIG. 1, raw water is pumped by centrifugal pump 10 to the oxygenation tank 80. Valve 20 is a sampling valve for collecting water samples to assess quality of the water entering the plant 1 for treatment. Pressure gauge 30 is a visual indicator of system pressure for the first part of the system leading to the oxygenation tank 80. Flowmeter 40 monitors the flow of water through the plant control system with measured flow being used for adjusting the speed of pump 10 to maintain targeted programmed flow. The pH transmitter 50 is used to measure the inlet water pH and in conjunction with pH transmitter 150 regulates the pH to be achieved through the amount of ferric chloride to be dosed by the dosing unit 70. The target pH to be measured at pH transmitter 150 is, by way of convenient example, 4 to optimise degradation of oxidisable NOM (and other contaminants) and coagulation performance. To reach target pH, in addition to ferric chloride, hydrochloric acid or other acid is dosed through dosing unit 75 to acidify the water to pH 4 (though pH of up to about 5.5 may be used with benefit still achieved without adverse impact on the downstream catalytic reactor(s)). An amount of ferric chloride to be added may depend on the measured NOM content of the raw water and its addition causes Fenton like reactions which oxidise a portion of contaminants in the water through reaction of reactive radicals with the oxidisable contaminants.

Turbidity transmitter 60 monitors the turbidity of the water to be treated. Depending on the quality of raw water, the dosage of ferric chloride may be increased so that higher turbidity water is dosed with more ferric chloride for coagulation. In addition, raw water with higher dissolved NOM requires a higher dosage of ferric chloride. An ultraviolet transmittance (UVT) instrument 65 is used to relate the UVT to the amount of dissolved NOM. Both measurements of turbidity and UVT are applied for controlling the amount of ferric chloride to be dosed and, potentially, quantities of oxygen to be introduced as described below later in the process. It will be understood that the NOM content could be measured by other analytical techniques.

The oxygenation tank 80 is provided with a drain valve 90 to allow emptying of the tank 80 for service cleaning. The oxygenation tank 80 has internal baffles so that most of the water will overflow passing over the internal baffles 120 for good mixing. The internal baffles are provided at the bottom with removable covers to allow water to drain when draining the tank for cleaning. The oxygenation tank 80 is enclosed, communicating with the atmosphere through air filter 140.

The oxygen transmitter 130 measures the oxygen content of the gas in a headspace above the water level of oxygenation tank 80. The oxygen content is above 21 vol % and desirably substantially higher than this. The information is used, by the plant control system, to control the flow of oxygen supplied by the pressure swing adsorption (PSA) generator 100 into the water through fine bubble diffuser 110. Dissolved oxygen can be increased well above 15 mg/L, even to 30 mg/L, at which level oxidation of contaminants in the water of oxygenation tank 80 is highly efficient.

A pH transmitter is used to monitor the pH of water treated in the oxygenation tank 80 and to correct dosage of ferric chloride (for example as a 40% ferric chloride solution in water) to meet the pH target 4 through dosing unit 70. Sampling valve 160 is for collecting water samples to be analysed for assessment of water treatment through the oxygenation stage.

Dosing unit 170 is used for dosing calcium hydroxide or other alkali for raising the pH to target 7.5 to 8.5 and causing coagulation in step (d). For small capacity plants, sodium hydroxide may be used due to simplicity of dosing and treatment. Cost of sodium hydroxide is much higher than that of hydrated lime and for large capacity plants calcium hydroxide is used, at least at this front end of the process. When using calcium hydroxide typical conventional re-carbonation is needed. Re-carbonation with carbon dioxide precipitates excess calcium hydroxide as calcium carbonate. Such re-carbonation process is not shown in the diagram in FIG. 1. Valve 160 is a sampling valve for collecting water samples from this stage of the treatment process for analyses.

Coagulation tank 180 has internal baffles 190 open at one end so that the water travels across each mixing and coagulation compartment defined by baffles 190 and including mixers 200. The output end of the tank 180 should be open to atmosphere to allow for gas release and avoid flotation of coagulated material. For reaching final pH, a small addition of sodium hydroxide reduces the excess of calcium hydroxide and re-carbonation may be avoided. Sodium hydroxide dosage is done through dosing unit 205.

Mixers 200 are provided with a variable frequency drive controlled by the plant control system. Mixer 200 in the first compartment is controlled to run at high speed for initial mixing of calcium hydroxide slurry with the water. Mixers 200 in the second and subsequent compartments are run at lower speed suitable for coagulation. Tapered mixing may be used, decreasing the mixing speed towards the exit of the tank 180.

Valve 210 is used for draining the tank for cleaning. Sampling valve 220 is for collecting and assessing the quality of coagulated water. pH transmitter 230 monitors pH of coagulated water and the measurement is used for correcting the dosage of alkali amount through dosing unit 170. Target pH, by way of convenient example, is minimum 7 and maximum 8.5.

Dosing unit 240 adds an amphoteric polymer flocculant, such as a polyacrylamide, for flocculation of coagulated solids. Mixing for flocculation is achieved through mixer 260. Precipitation of flocs and separation of sludge happens in the inclined plate clarifier 270. Sludge collects at the bottom of the clarifier and is intermittently discharged by opening the electrically operated valve 280. The clarifier 270 to be used need not be an inclined plate type but can be of any other known type as known in the art. A clarifier may be omitted if volume of sludge produced by coagulation/flocculation is low.

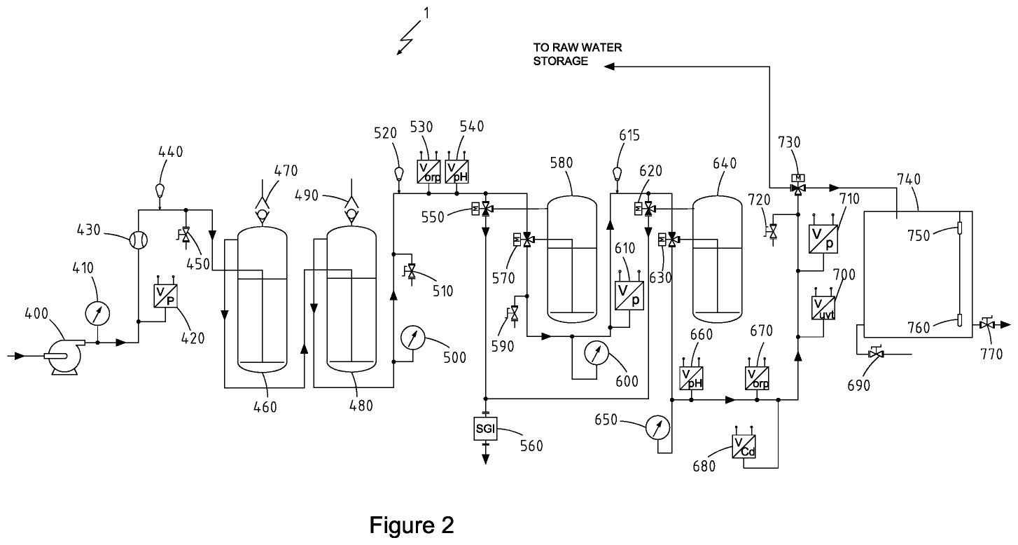

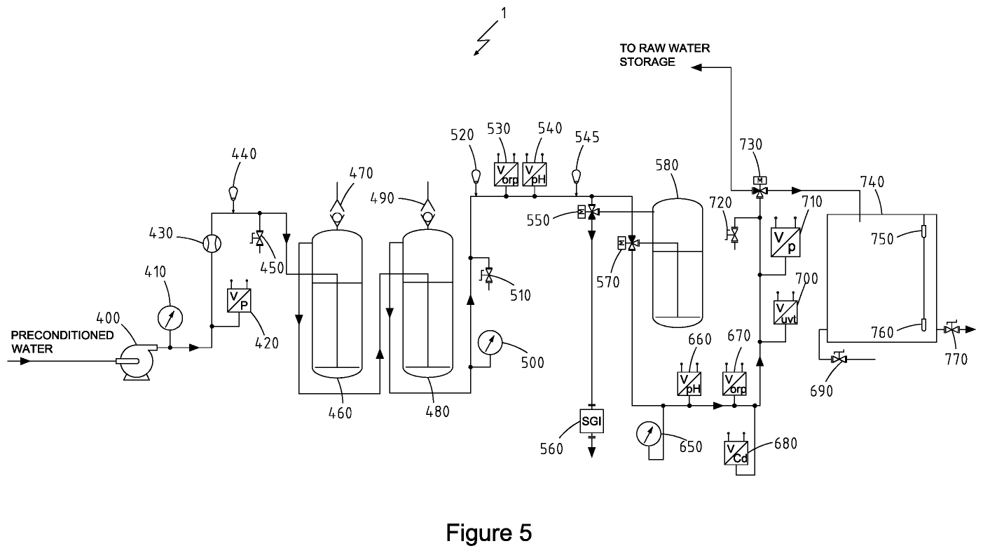

Clarified water flows into the break tank 290 needed because from time to time the water flow and treatment through downstream CO-CAO reactor(s) is interrupted for backwashing. The CO-CAO reactors may include the catalytic reactors 580 and 640 shown in FIG. 2 or the single catalytic reactor 580 of FIG. 5. The break tank 290 is enclosed, communicating with the atmosphere through air filter 330. Oxygenation is applied at this stage for increasing dissolved oxygen needed for the catalytic oxidation—catalytic advanced oxidation (CO-CAO) stage(s). Oxygen is produced by the PSA generator 310 and released into the water through fine bubble diffuser 320. The oxygen concentration in the headspace above the water level in break tank 290 is monitored by transmitter 340. Oxygenation contact time required at this stage is much less than in the initial oxygenation stage when oxidation of organic matter is targeted. Suitable contact time required at this stage was found to be around 10 minutes.

Break tank 290 full level is confirmed by level switch 350. At full level, water treatment in the conditioning section has to be stopped to prevent overflow. Level switch 360 confirms empty level of the break tank 290 and water processing through the CO-CAO stage then has to stop. Valve 370 is used to isolate water supply when the pump 400, in the CO-CAO section of FIG. 2 or FIG. 5 needs maintenance. Turbidity transmitter 380 monitors turbidity of the pre-conditioned water and is used to make correction to pH control and ferric chloride/alkali addition in the pre-conditioning stage of the treatment. Valve 390 is a sampling valve for collecting water samples to assess quality of the water after the clarification step as described here.

With reference to the module of FIG. 2, which is combined with the module of FIG. 1, there is shown one possible arrangement of the CO-CAO water treatment stage of water treatment plant 1, when the dissolved NOM content, as determined by UVT in this case, is high.

Centrifugal pump 400 is used to pump the water through this section for enabling: CO-CAO treatment, backwashing and rinsing of the CO-CAO section. Pressure gauge 410 is a visual indicator for the system pressure. The pressure should be identical or very close to the measurement by pressure transmitter 420. Pressure transmitter 420 in conjunction with pressure transmitter 630 is used to calculate pressure drop mostly caused by solids accumulation in the bed of reactor 580. At a set level of differential pressure, backwashing of reactor 580 is triggered. In similar manner, pressure transmitters 610 and 710 are used to calculate differential pressure over the reactor 640 and trigger backwashing of reactor 640 when set maximum level is reached. Flow meter 430 measures the effective water flow which is compared in the control system with the set target flow for the particular operating mode of the plant (normal, backwash or rinse) and the speed of pump 400 is corrected accordingly for maintaining target flow.

In the normal mode of CO-CAO treatment, the water is dosed with oxygen donor, here potassium permanganate, by dosing unit 440. The result of the dosage can be verified by collecting and analysing water sample through sampling valve 450. Water dosed with oxygen donor passes through reaction tanks 460 and 480 to allow oxidation reactions to take place. The two reaction tanks are conveniently selected to be of the same internal diameter as CO-CAO reactors 580 and 640. Reaction tanks 460 and 480 are each bed reactors which have coarse sand beds of 260 mm height to achieve uniform speed of the water in the cross section of the reactors 580 and 640. This arrangement makes possible removal of any sediment or precipitate accumulated in the reactor tanks 460 and 480 when the CO-CAO reactors 580 and 640 are backwashed. The same backwash speed is used in all tanks. After allowing for reaction time in tanks 460 and 480, the water passes through CO-CAO bed reactors 580 and 640 arranged in series. Dosing unit 615 adds further oxygen donor in front of reactor 640 if needed, depending on level of dissolved NOM downstream from first CO-CAO reactor 580 and dissolved NOM measured in sample collected at valve 720.

Thus, if more dissolved NOM needs to be removed, more oxygen donor may be added. The oxygen donor dosed by unit 615 may conveniently be the same as the oxygen donor dosed by unit 440. However, if the oxygen donor is different and does not contain a catalytic metal (for example iron or manganese) then a small amount of catalytic metal has to be also added for example by adding potassium permanganate or ferric chloride. This is necessary if for example the oxygen donor is hydrogen peroxide. Hydrogen peroxide will work well with addition of an iron salt such as ferric chloride. Water downstream of reactor 640 is monitored for quality compliance and if it is outside acceptable parameters, the water is diverted to raw water storage through valve 730. Otherwise, the water is sent to treated water storage and used as potable water or subjected to further treatment, such as adsorption or ion exchange for ammonia removal. If no further treatment is needed, then the water may be dosed with disinfectant, such as chlorine, to provide a residual for storage and distribution.

Backwashing is done with clarified water. During the backwashing, speed of pump 400 is increased to deliver the backwash flow, usually higher than normal mode flow. Dosing unit 520 will also dose a disinfectant such as chlorine or chlorine dioxide to disinfect the catalytic beds of the respective reactors 580 and 640.

First, the catalytic reactor 580 is backwashed. Valves 550 and 570 change position and the water travels from bottom to top inside the reactor expanding the bed and entraining solids and precipitate. Water exiting the catalytic reactor 580 is directed to waste by valve 550. Next, for backwashing reactor 640, valves 550 and 570 rotate back into normal mode position and valves 620 and 630 move into position for backwashing catalytic reactor 640. Water enters the reactor 640 through valve 630 and travels upwards inside the reactor, expanding the catalytic bed and entraining solids including those produced by the treatment process.

Spent backwash water is directed to waste by the valve 630. During backwashing of reactor 640, the reactor 580 is operated in normal mode and due to water flow higher than normal mode the bed will be submitted to higher pressure drop and compaction. Thus, after backwashing reactor 640 a short one minute backwashing is done again for reactor 580 to expand the bed and reduce compaction. The reactor bed settles back after finishing backwashing. The water quality through the settled bed is not usually of the normal water quality and rinsing of the beds is desirably carried out. For rinsing, the catalytic reactors 580 and 640 are operated in normal mode but the water is diverted to raw water storage rather than potable water storage by valve 730.

Rinsing is also conveniently used to displace, from the reactor beds, backwashing water containing disinfectant which may not be desired in the treated water storage tank. For example, chlorine disinfectant may be not compatible with materials in the water distribution network or with further treatment. For example, if further treatment is required to remove NOM through carbon adsorption, the chlorine in the water will be adsorbed by the carbon filter, thus it will impact negatively on the capacity of the absorber. It is also possible to setup the backwashing system using stored treated water and dedicated pump, valves and plumbing as is often the case with filter backwashing in a conventional water treatment plant.

Following functional description of the items in FIG. 2, the reaction tanks 460 and 490 allow for preliminary oxidation to take place. Each reaction tank 460 and 490 is provided with an automatic air vent valve, 470 and 490. Pressure gauge 500 is a visual indicator of pressure before the CO-CAO first reactor 580. Samples, to check water quality following pre-oxidation could be collected using sampling valve 510. Dosing unit 520 is used during backwashing to dose disinfectant.

ORP of the water is monitored by ORP transmitter 530 and pH is monitored by pH transmitter 540. Most suitable is chlorine dioxide, though chlorine and other disinfectants may be used. Water entering the catalytic reactor 580 has a target ORP not less than 400 mV for efficient CO-CAO reactions to proceed. ORP can be increased by increasing flowrate of oxygen from the PSA oxygen generator 310 to be injected into the water through diffuser 320, as described with reference to FIG. 1 and by increasing the oxygen donor dosage by dosing unit 440.

In addition, pH is adjusted within a suitable range. Regardless of the target pH of finished water, the pH at this stage should not be lower than 6 otherwise damage of the catalytic bed could happen. The catalytic metal oxide material, as described below, may dissolve into the water under excessive acidic conditions. Strong reducing conditions, ORP approaching zero or negative, can damage the catalyst. In the position as represented, valves 550 and 570 direct water to be treated in normal mode through the catalytic reactor 580.

Water enters the reactor 580 at the top side and travels downwards through the catalytic bed. The catalytic bed comprises granular metal oxide catalyst (by way of example a combination of iron, manganese, aluminium and titanium oxides as described above) and a top layer of large size and lower density particles than the metal oxide catalyst particles to accommodate suspended solids at the top of the bed, inside reactor 580, from top to bottom. The top layer could be of anthracite.

For backwashing the reactor 580, the position of the two valves 550 and 570, is rotated 90 degrees and the water travels upwards through the reactor and is directed to waste. Item 560 is a sight glass to observe spent backwash water quality and adjust duration of backwashing. Backwashing can be stopped when the backwash spent water is clear enough as measured by sight or a turbidity transmitter. Pressure indicator 600 shows the pressure ahead of the second catalytic reactor 640. Pressure transmitter 610 monitors the pressure ahead of the second catalytic reactor.

Dosing unit 615 is used for further addition of oxygen donor and metal catalyst if needed to degrade more and decrease the concentration of dissolved NOM further.

Valves 620 and 630 are shown in normal mode of operation whereby the water travels through the catalytic bed, comprising granular metal oxide catalyst (a combination of iron, manganese, aluminium and titanium oxides as described above). There is no top layer of large size and lower density particles as for first catalytic reactor 580 because the amount of precipitate required to be retained in the catalytic bed at this stage of the water treatment is very low. For backwashing, the position of the valves 620 and 630 is rotated 90 degrees and the water travels from bottom to top expanding the catalytic bed and entraining solids retained in the bed. Then, the spent backwash water is directed to waste by valve 620.

Water treated through CO-CAO reactors 580 and 640 is checked for pH, conductivity, ORP and UV transmittance to verify that is within desired quality limits. pH is monitored by pH transmitter 660, ORP is monitored by ORP transmitter 670 and conductivity is monitored through conductivity transmitter 680. The UV transmitter is used to estimate dissolved NOM content. In this case, the treated water does not contain residual disinfectant for storage and distribution. If there is no further treatment and the water is to be stored and distributed, a dosing system to provide residual disinfectant is needed. Commonly, the residual disinfectant is a chlorine based chemical and free chlorine will be monitored and used for disinfectant dosage control. It is to be understood that the process itself causes water disinfection and chlorine is added as a residual to the potable water fraction produced by the process only where required by custom or regulation.

The main purpose of pressure transmitter 710 is to calculate differential pressure over the catalytic reactor 640 and trigger backwashing of catalytic reactor 640 when set value is reached. Sample of finished water could be collected at sampling valve 720. Valve 730 directs the treated water in normal mode of operation to storage. During rinsing mode or if the water is not of suitable quality, the valve 730 changes position and water is returned to raw water storage.

Test results proved that this treatment process is suitable for NOM and other contaminants removal from water and found that TOC, and DOC reduced from 6 to 3 and the turbidity decreased from 2.6 to less than 0.1.

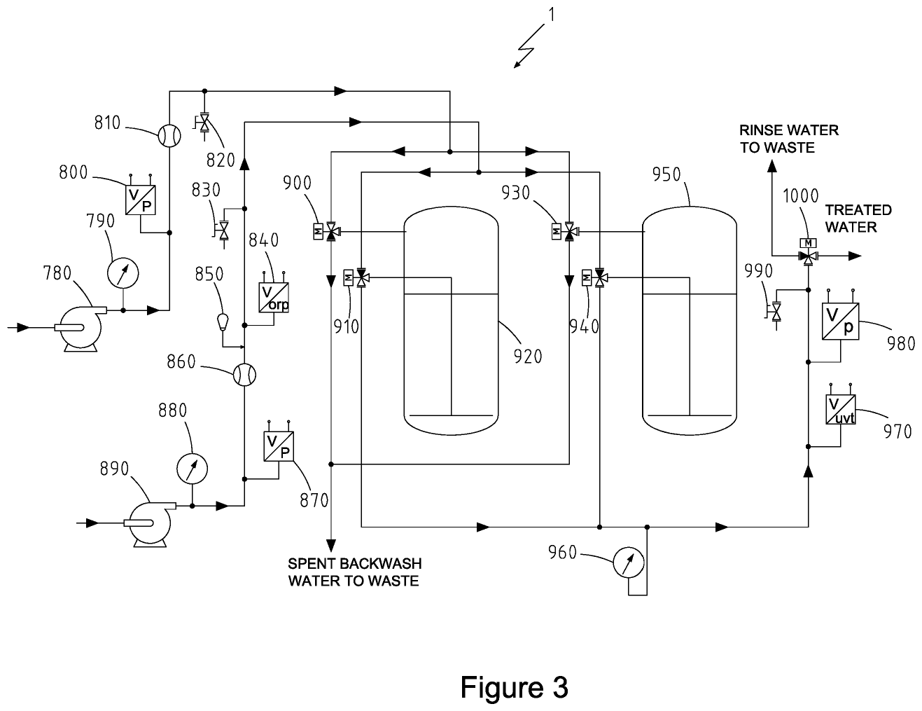

With reference to FIG. 3, the process diagram shown is of a module for removal of a low concentration but more refractory part of NOM and low concentration of various other dissolved contaminants in a raw water, using a granular activated carbon (GAC) filter adsorber. This module could be used in combination with the modules shown in FIGS. 1 and 2. It is to be understood that other adsorbents, such as zeolites, could also be used as an alternative. The illustrated configuration provides two GAC filter adsorbers 920 and 950 in parallel. Water treated through CO-CAO treatment, conveniently as above described, and stored in tank 740 is pumped through the GAC filter adsorbers 920 and 950 by pump 780 for normal mode of operation. Pressure gauge 790 shows the total system pressure for this treatment section. Pressure transmitter 800 monitors system pressure and in conjunction with pressure transmitter 980, the differential pressure drop over the filter adsorbers is calculated. This is used to trigger backwashing and partial regeneration of GAC filter adsorbers 920 and 950. The GAC filter adsorbers 920 and 950 are used and backwashed alternately so that the water treatment plant does not have to be interrupted for long during backwashing and regeneration of a GAC filter adsorber. Flow rate is monitored by flowmeter 810. Typical bed contact time for the GAC filter adsorbers is 20 minutes using one adsorber at a time. Valves 900 and 910 are used for setting normal downwards flow through the GAC filter adsorber 920. By changing valve position 90 degrees the backwash mode is set. In similar manner, valves 930 and 940 set normal downwards flow through the GAC filter adsorber 950 and backwash flow direction when rotated 90 degrees. For setting GAC filter adsorber 920 in standby mode, valve 900 only is rotated 90 degrees and no water will flow through the GAC filter adsorber 920. In similar manner, valve 930 is used for setting in standby mode GAC filter adsorber 950. Pressure gauge 960 indicates the pressure downstream from the filter adsorbers. Pressure transmitter is used to calculated pressure drop over the filter adsorbers and trigger backwashing and partial regeneration. The UV transmitters monitor the UV transmittance to estimate dissolved NOM in water passing the filter adsorbers 920 and 950. This will detect the need for regeneration or replacement of the adsorbent material in the filter adsorbers 920 and 950 when the dissolved NOM reaches maximum acceptable limit. Water quality can be checked by collecting samples using valve 990. Valve 1000 is used for discharging water to waste following backwashing of the filter adsorbers 920 and 950 or if the treated water does not meet quality standards in regard to dissolved NOM.

Water for backwashing the filter adsorbers 920 and 950 is also sourced from storage tank 740. Pump 890 is used for delivering the water for backwashing the filter adsorbers 920 and 950. Pressure gauge 880 is a pressure indicator for indicating the pressure during backwashing. Pressure transmitter 870 indicates system pressure for the backwash part of this section. The flow transmitter monitors the water flow and is used for regulating the speed of pump 890 for maintaining target water flow during backwashing. The flow meter 850 will also measure water volume for regenerative soaking of each filter adsorber bed. The particular filter adsorber 920 or 950 is slowly filled to the full volume with water dosed with hydrogen peroxide. Depending on concentration of hydrogen peroxide and state of the adsorbent bed the soaking will take a few hours. Following soaking, the filter adsorber 920 and 950 is backwashed. Valve 830 is used for collecting water sample for the water used for soaking. Water treated through the filter adsorbers 920 and 950 has no residual disinfectant. Particle breakage from the filter adsorbers 920 and 950 may escape from time to time. Thus dosage of residual disinfectant, if needed, has to be added downstream from filter adsorbers 920 and 950. A cartridge filter or membrane filtration unit with filtration resolution of 1 micron or less is desirably provided downstream from the filter adsorbers 920 and 950.

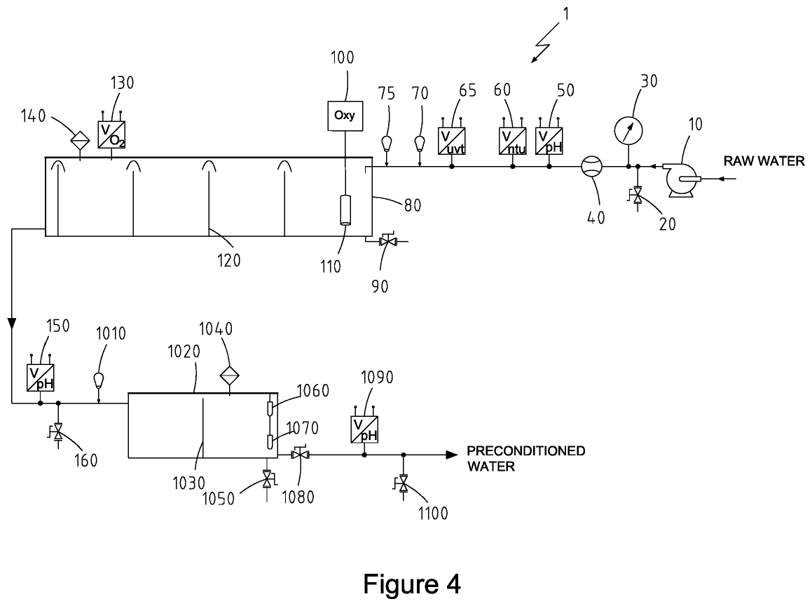

FIG. 4, is a process diagram of a pre-conditioning stage for treatment of raw fresh water to be treated for first stage oxidation. This process configuration could be used when the raw water has low concentration of suspended solids and colloidal matter. Settling of suspended solids and sludge removal is not needed in this embodiment. Compared with the pre-conditioning process in FIG. 1, the process diagram is identical up to the point of dosing alkali downstream of sampling valve 160. In FIG. 4, dosing unit 1010 is used for dosing an alkali which will not generate precipitate by itself, preferably sodium hydroxide. Tank 1020 is used for reaction time, much shorter than in case of using hydrated lime. Ten minutes reaction time is adequate as there is further downstream time for completing the reactions associated with increasing the pH.

Reaction tank 1020 is provided with baffles 1030 for improving flow conditions in the reaction tank 1020 so that all water has the same residence time. Reaction tank 1020 is enclosed and connected to the atmosphere through air filter breather 1040. In this way, a large amount of dissolved oxygen can be preserved in the water and there is no need for a boost through a second oxygen infusion as in the pre-conditioning system shown in FIG. 1. Level switch 1060 confirms that tank 1020 is at maximum level and level switch 1070 confirms tank empty condition. Valve 1050 is a drain valve to be used for water release during cleaning of that tank 1020. Valve 1080 is used to isolate the pipeline downstream when the tank needs to be cleaned or for servicing downstream equipment. The pH of water is monitored by pH transmitter 1090 and dosage of alkali by unit 1010 is adjusted to meet target pH. Pre-conditioned water sampling for analyses is done by collecting water samples using water sampling valve 1100.

This pre-conditioning module may be used upstream from module in FIG. 2 or module shown in FIG. 4 depending on the water quality to be further treated. In this embodiment, TOC and DOC were decreased to 3 from 6-6.8.

FIG. 5 is a process diagram of a CO-CAO stage of treatment for pre-conditioned water through treatment module shown in FIG. 1 or FIG. 4. This process configuration may be used when the raw water has a relatively low concentration of dissolved NOM. The process shown in FIG. 5 uses only one CO-CAO reactor 580. The CO-CAO reactor 580 is the same as first reactor used for the process diagram in FIG. 2. The functionality of all components shown in FIG. 4 is the same as for identical item numbers used in FIG. 2. By difference dosing system 545 was added to provide a filter aid polymer to improve retention of colloidal solids in CO-CAO reactor 580.

A validation study was conducted to measure output quality of water following treatment by the process operating at nominal operational conditions to remove and/or inactivate microorganisms seeded into groundwater and also validate its performance for treating water for production of potable water. The pre-conditioning was a batch processing process similar to the process shown in FIG. 4. The CO-CAO module used was the same as the one shown in FIG. 5, with one CO-CAO reactor 580 with the exception that no filter aid polymer was added. The intent was to create conditions less than ideal for the validation test. The validation results confirmed the following log₁₀ removal of pathogens:
Bacteria (E. coli)>4.1
Viruses (MS2)>6.3
Protozoa (Cryptosporidium sp)>4.2

E. coli and MS2 pathogens are used live for spiking. Cryptosporidium sp was inactivated through gamma irradiation before used and shown log₁₀ removal was achieved through removal/interception. This was to avoid the high infectivity risk during validation tests. According to regulatory requirements, maximum log₁₀ removal attributed to a single unit operation is 4.

Pre-conditioning module for plug flow operation shown in FIG. 1 and FIG. 4 could be assessed in field validation as independent barrier for disinfection. Thus, the overall treatment system as described in this disclosure, could be validated as two barriers. Total log₁₀ removal is expected to be higher than in the validation test because the log₁₀ removal of the treatment system is the sum of the log₁₀ removal of the two barriers for each of the pathogens.

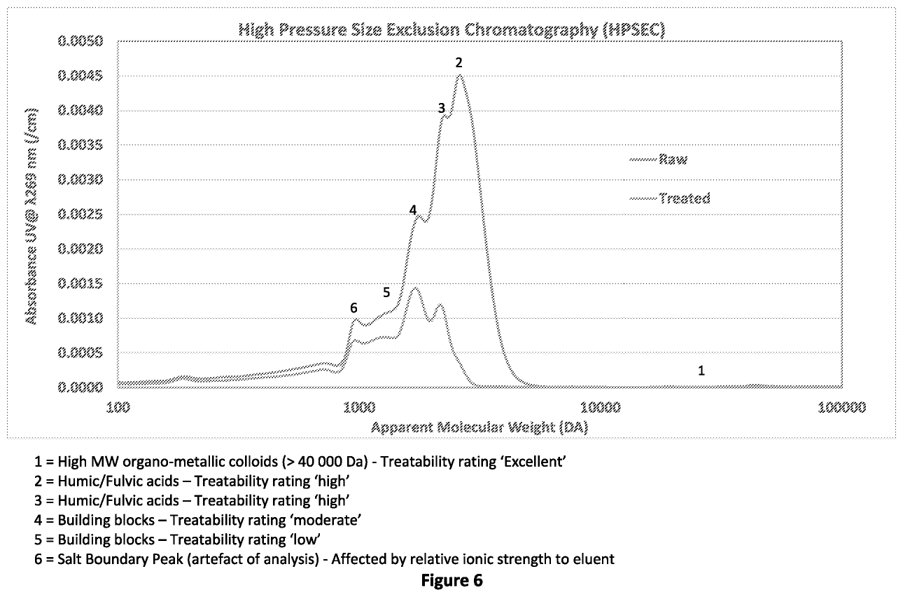

With regard to FIG. 6, the HPSEC plot shows the reduction of organic matter through the process of the invention. The curve with highest UV adsorption peaks show dissolved NOM concentration and molecular size distribution. Substances with high molecular weight represent humic and fulvic acids and are typically easier to degrade through advanced oxidation. Resistance to degradation increases with the decrease in molecular size. The lower curve shows the concentration and molecular size distribution of dissolved NOM of treated water without a final polishing treatment through carbon adsorbents, for example by using GAC filter adsorbers. It may be noted that most of the humic and fulvic acids are degraded. Experimental work confirmed that the humic and fulvic acids present in this raw water react very fast with chlorine producing DBPs. This process removed significant amount of humic and fulvic acids. Also, the remaining dissolved NOM is of more refractory nature and does not react easily with chlorine. Thus, the potential of forming chlorinated DBPs is reduced.

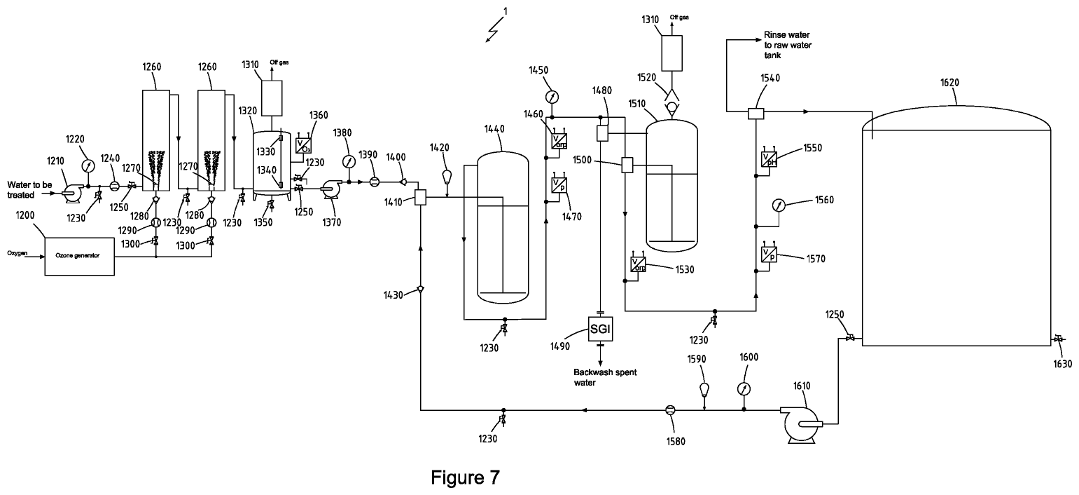

FIG. 7 is a process diagram of a CO-CAO for upgrading utility drinking water plants for compliance with DBPs resulting from chlorination and for degradation and removal of CECs. Many water utility plants have serious difficulties in achieving required water quality due to continuous increase in contamination of water sources. In addition, more restrictive regulations are introduced with regard to DBPs and CECs. Large numbers of treatment plants for drinking water production are already using fragmentation of NOM with ozone followed by BAC filtration or biological filtration. The concept is based on the observation that ozone treatment could economically fragment organic matter to a more biodegradable form. But sometimes a large part of the fragmented NOM is not biodegradable and DBPs in the water distribution network exceed regulatory maximum contaminant limit. The present inventors confirmed through experimental work that water with NOM fragmented through ozonation can be more efficiently treated through CO-CAO. Efficiency of degraded NOM has shown to be higher than in the case of using biodegradation. Ozone can also be used for catalytic advanced oxidation in conjunction with a catalyst. The inventors used fragmentation of NOM with ozone, followed by addition of potassium permanganate. The colloidal manganese dioxide formed in the bulk of the water catalyses ozone for production of hydroxyl radicals. Degradation of NOM is very efficient only limited by the amount of ozone available in the water. The water, still containing some amount of ozone, manganese dioxide and potassium permanganate reaching the granular catalytic bed in the CO-CAO reactor further produce CAO oxidation reactions. Ozone is a polar molecule and is attracted to the catalytic surfaces in the CAO reactor. Ozone is decomposed and the manganese dioxide is retained. Reactions can be adjusted so that the ozone residual is very low and there is no need for ozone quenching downstream. If the fragmentation of NOM through ozonation results in large amount of neutral organic matter, the existing plants could be more economically upgraded maintaining the ozonation and BAC filtration in place. Then a simplified form of CO-CAO, without clarification may be used. The optimum solution for a particular water composition could be determined through pilot field testing.

In FIG. 7 the clarified or filtered water is pumped by pump 1210 though two ozone contact tanks 1260 into a further ozone contact and break tank 1320. Using two ozone contact tanks in series result in a more efficient ozone transfer to the water and to the process. Pressure gauge 1220 indicates the system pressure downstream from pump 1210. Valves 1230 are used for water sampling. The flow is monitored through flowmeter 1240 and regulated to a target flow in conjunction with adjusting the rotational speed of pump 1210 using a variable frequency drive. Parameters to be measured for the feed water to ozonation are the flow rate and contaminant concentration in the feed water. The contaminant, NOM concentration is measured by analyses of grab samples. Valves 1250 are manual valves for closing the water circuit to prevent water spills when adjacent components need service or replacement. The ozone generator 1200 should have the capacity of supplying up to 5 mg/L ozone to the water to be treated if only fragmentation of NOM is targeted and up to 10 mg/L ozone when, in addition, CAO is targeted in the bulk of the water and in the CAO reactor. The maximum dosage depends on the amount of NOM to be degraded. For fragmentation, 1 mg/L ozone per mg/L DOC is typically enough. For mineralization through alternative Advanced OxidationAOP processes, such as O3/H2O2, the dosage of ozone needed is 3 times higher. The processes described herein require less ozone concentration for mineralization of NOM than alternative AOPs. The ozone generator 1200 may be provided with its own gas flowmeter and instrument for ozone concentration in the gas. Current corona discharge generators have an optimum efficiency at around 7% ozone concentration in gas. Manual valve 1300 is used for adjustment of ratio of split flow between the two ozone contactors. The first ozone contactor tank receives a higher flow of ozone than the second ozone contactor. Flow ratio is adjusted by monitoring flow meters 1290. Non-return valves 1280 prevent water backflow when pressure in the ozone feed line may be lower than the water pressure in the ozone contactor tanks. Ozone is fed at the bottom of the ozone contactor tanks through fine bubble diffusers 1270. Ideal height of the water in the ozone contactor tanks should be a little more than 6 m. Practically constructing contact tanks or columns with this depth of water is not always convenient. Multiple contact tanks could be used in series before venting off the gas. In the process diagram in FIG. 7 the contact of gas for ozone transfer is extended by using two contact tanks and a break tank 1320. The off gas is passed through ozone destructor 1310 and vented off. Parameters to be measured for the gas input to the process are ozone concentration in gas, and gas flow rate. For completing the information on process mass balance, the concentration of ozone in the gas before the ozone destructor has to be monitored and also the concentration of ozone in the treated water. For measurement of concentration of ozone in the treated water instrument 1360 is provided. NOM concentration and state of fragmentation could be measured by analysing grab samples. The break tank 1320 is provided with float level switches 1330 for full level and 1340 for empty level. Valve 1350 is used for draining the tank when cleaning. When the ozonation is used just for fragmentation of NOM the concentration of ozone should be very low at the end of the ozonation process. Targeted concentration is not detected or lower than 0.05 mg/L dissolved ozone concentration. When ozone AOP has to be produced, then the ozone concentration in tank 1320 has to be around 1 mg/l dissolved ozone per 1 mg/L DOC or higher. The water from tank 1320 can be further processed through CAO oxidation through CAO reactor 1510 containing granular metal oxide catalyst. This is when no dissolved ozone is present in the water to be treated. Alternatively, the water containing dissolved ozone is dosed with potassium permanganate catalysing AOP with dissolved ozone. Pump 1370 is controlled through variable frequency drive for flow adjustment. Pressure gauge 1380 is a visual indicator of system pressure downstream from pump 1380. The flowmeter 1390 monitors the flow for comparing it to target flow in the control system and adjustment through varying rotational speed of pump 1370. Non-return valve 1400 prevents backflow of backwash water towards the pump 1370 when backwashing the CAO water circuit and reactor. Valve 1410 is a three-way selector valve to allow water flowing through from backwash pump 1610 or from the pump 1370. In normal mode of operation the water from tank 1320 passes through valve 1410 and is directed towards reaction vessel 1440. Dosing unit 1420 is adding potassium permanganate. The added potassium permanganate is used for pre-oxidation and as oxygen donor and for providing catalytic metal to CAO reactor 1510. In case dissolved ozone is present in the water, potassium permanganate provides metal catalyst for homogeneous CAO reactions in the bulk of the water, ahead of the catalytic reactor 1510. Reaction tank 1440 is sized depending on required hydraulic retention time for reactions to take place. The time required is minimum 3 minutes. For mineralization of large amount of NOM, homogeneous AOP multiple reactors of the same size as 1510 reactor vessel can be used in series. This extends the hydraulic retention time for reaction while makes possible convenient removal of any settled solids when CAO reactor 1510 is backwashed. This is because upwards water speed in the vessels will be the same, high enough to entrain the settled solids. Pressure transmitter 1470 in conjunction with pressure transmitter 1570 are used to measure the differential pressure across CAO reactor 1510 and trigger backwashing at set reference differential pressure in the control system. ORP is an important parameter for the CAO reactions to take place. Targeted ORP is 500 mV or more and should not be lower than 400 mV depending on water pH. Pressure gauges 1450 and 1560 are used as visual indicators to confirm the reading of the pressure transmitters in their proximity. In normal operating mode water passes through valve 1480 and into upper side of CAO reactor 1510. The water travels downwards through the catalytic bed. At the bottom of the filter container, lateral slotted pipes collect the water into a central rising pipe. The water reaches valve 1500 and is directed towards valve 1540. ORP transmitter 1530 is to relate the condition of treatment to capacity of CAO taking place in the reactor 1510 and to check the condition of ORP transmitters by verifying typical offset between the two transmitters 1460 and 1550. CAO reactor 1510 contains granular metal oxide catalyst. If the incoming water contains ozone the gas escaping from the reactor through venting valve 1520 may also contain ozone. Thus, the venting gas is passed through an ozone destructor 1310 before final venting to atmosphere. Downstream from CAO reactor 1510 the water may be dosed with residual disinfectant for storage and distribution if needed (dosing unit not shown). From valve 1540 water is directed to the product water tank 1620. Rinsing of the CAO reactor follows backwashing and in that case valve 1540 directs the water for recovery to the front of the treatment train. Product water tank 1620 has connecting valve 1630 for further water transfer and may be provided with water level monitoring and air filter breather. Backwashing is done using clean treated water. The backwash pump is driven through variable frequency drive. Flowrate is controlled in conjunction with flow rate monitoring by flowmeter 1580. Pressure indicator 1600 shows the pressure level in the backwash system. Non-return valve 1430 prevents water backflow into the backwashing line when the plant is operated in normal or rinse mode and valve 1410 may not seal properly.

The following Examples of performance in degradation of organic matter for a plant using ozonation and BAC are based on laboratory experimental work on water samples provided by the water utility. The water utility is experiencing serious problems with excessive trihalomethanes (THMs) in the water distribution network.

### Example 1

A water treatment plant incorporated the following process steps:
Raw water->Clarification->Ozonation->BAC filtration->Chlorination->Finished water

Analysis results of the raw water, the water after clarification, and the water after BAC treatment are shown in Table 1. Removal of TOC by existing ozonation followed by BAC varies between 13% to 19%. Further, the THM level in the water was greater than 250 μg/L. This represents a potentially serious public health issue.

TABLE 1

| Parameter | Units | Raw water | Clarified | BAC treated |
|---|---|---|---|---|
| TOC | mg/L | 15-18 | 7.5-8 | 6.5-7 |
| Colour | HU | 150 | 7 | 1 |
| Turbidity | NTU | 7 | 7 | <0.1 |
| TOC removal | % | — | 50-58 | 13-19 |
| THMs formation | μg/L | | | >250 |

### Example 2

Clarified water from the existing plant was conditioned and subjected to two CAO treatments.

Conditioning involved adjusting the pH to between about 7.5 and about 8.0 and the ORP to target 500 mV or higher.

TABLE 2

| | | | | CAO | CAO |
|---|---|---|---|---|---|
| | | | Conditioned | one | second |
| Parameter | Units | Clarified | for CAO | pass | pass |
| TOC | mg/L | 8 | 7.1 | 5.7 | 5.2 |
| Colour | HU | 10 | <1 | <1 | <1 |
| Turbidity | NTU | 0.3 | 7 | <0.1 | <0.1 |
| TOC removal | % | — | 11.2 | 29 | 35 |
| THMs formation | μg/L | — | — | 60 | 48 |

The results indicated a significantly improved removal of TOC and a much lower level of THM.

### Example 3

Clarified water from the existing plant was treated through ozonation, homogeneous CAO with ozone, and two stages of CAO with granular metal oxide catalyst.

TABLE 3

| | | | Homogeneous | CAO | CAO |
|---|---|---|---|---|---|
| | | Clarified | CAO with | one | second |
| Parameter | Units | water | ozone | pass | pass |
| TOC | mg/L | 7.3 | 3.0 | 3.1 | 3.2 |
| Colour | HU | 10 | — | — | <1 |
| Turbidity | NTU | 0.2 | — | — | <1 |
| TOC removal | % | — | 61.5 | 59 | 58 |
| THMs formation | μg/L | — | — | — | 32 |

The results indicated a significantly improved removal of TOC and a much lower level of THM.

In Example 3, the concentration of ozone was much higher than that used for fragmentation of NOM in the existing plant. Homogeneous CAO with ozone showed remarkable capacity to mineralize NOM, but the consumption of ozone was high. The CAO reactor with granular metal oxide catalyst is still required at least for precipitating and retaining manganese dioxide resulting from potassium permanganate and for decomposition of residual dissolved ozone. The first and second CAO pass through the catalytic reactor with granular metal oxide catalyst show a slight increase in TOC. This is due to contamination from the materials used in the experimental stand and/or sample handling. When a final treatment step of absorption with GAC filtration is employed the experimental results consistently confirm removal of TOC to 1 mg/L or less and removal of residual CECs to undetectable levels. According to these experimental results it follows that for a particular source water composition different arrangements of process steps are required in order to achieve targeted outcome at minimal cost.

Modifications and variations to the water treatment process described herein may be apparent to the skilled reader of this disclosure. Such modifications and variations are deemed within the scope of the present disclosure. FIG. 1 to FIG. 5 and FIG. 7 each represent a module or a stage of the treatment process which could be combined with one or two other modules, for example as depicted in the other figures, for the desired treatment outcome.

1. A process for treating water containing natural organic matter (NOM) to produce potable water, the process comprising a plurality of oxidation steps for degrading NOM, wherein the plurality of oxidation steps comprise one or more of subjecting water to inorganic oxidant, oxygenation, catalytic oxidation, and catalytically advanced oxidation (CAO).

2. A process according to claim 1, further comprising the step of subjecting the water to biological filtration, such as biological activated carbon (BAC) filtration.

3. A process according to claim 1, further comprising the step of contacting water with granular activated carbon (GAC) for removal of remaining organic matter and for removal of potentially toxic fraction resulting from degradation of organic matter.

4. A process according to claim 1, further comprising treating water with chlorine to provide a residual disinfectant level in the water.

5. A process according to claim 1, comprising the steps of:
a) adjusting pH of water to a pH between 4 and 6;
b) forming reactive radicals, such as hydroxyl radicals, for example by adding a hydrolysing iron salt to the water of step (a);
c) oxygenating the water of step b) with an oxygen containing gas containing more than about 21% oxygen for degrading a substantial portion of organic matter;
d) coagulating suspended and colloidal solids where formed in step (c);
e) adding an oxygen donor oxidant to the water, for partial oxidation and to provide oxygen for catalytic oxidation step (f);
f) subjecting the water from step (e) to catalytic oxidation and catalytic advanced oxidation (CO-CAO) to degrade contaminants leaving a refractory portion of NOM;
g) optionally subjecting the water to GAC filtration for removal of refractory and potentially toxic residual organic matter.

6. A process according to claim 5 further comprising the step of subjecting the water to biological filtration, such as biological activated carbon (BAC) filtration.

7. A process according to claim 5, further comprising treating water with chlorine to provide a residual disinfectant level in the water.

8. A process for treating water for producing potable water, the process comprising a plurality of oxidation steps;
wherein the plurality of oxidation steps comprise one or more of fragmentation of NOM with ozone, homogeneous catalytic oxidation with ozone, and catalytically advanced oxidation using granular metal oxide catalyst.

9. A process according to claim 8, wherein at least one of the oxidation steps comprises fragmentation of NOM with ozone and/or homogeneous catalytic oxidation with ozone.

10. A process according to claim 8, wherein the process comprises at least one oxidation step with ozone, followed by at least one oxidation step involving catalytically advanced oxidation using granular metal oxide catalyst.

11. A process according to claim 8, comprising the steps of subjecting the treated water to BAC filtration to remove the biodegradable organic matter fraction, followed by CAO using metal oxide catalyst.

12. A process according to claim 8, comprising the step of contacting water with granular activated carbon (GAC) for removal of remaining organic matter and for removal of potentially toxic fraction resulting from degradation of organic matter.

13. A process according to claim 8, comprising treating water with chlorine to provide a residual disinfectant level in the water.

14. A process according to claim 8, wherein the water to be treated is conventionally clarified or filtered water.
